(19) United States
(12) Patent Application Publication
(10) Pub. No.: US 2026/0217244 A1
(43) Pub. Date: Jul. 30, 2026

(54) Method and System for Emergency Collision Avoidance of Intelligent Vehicle

(71) Applicant: TSINGHUA UNIVERSITY, Beijing (CN)

(72) Inventors: Junzhi Zhang, Beijing (CN); Jinheng Han, Beijing (CN); Chengkun He, Beijing (CN); Junfeng Zhang, Beijing (CN)

(21) Appl. No.: 19/148,792

(22) PCT Filed: May 23, 2023
(86) PCT No.: PCT/CN2023/095723

§ 371 Date: Jul. 17, 2025

(30) Foreign Application Priority Data
Jan. 18, 2023 (CN) 202310084807.7

(51) Int. Cl. B60W 30/095; B60W 50/00; B60W 60/00

(52) U.S. Cl. CPC B60W 30/0956; B60W 50/0098; B60W 60/001; B60W 2050/0031; B60W 2520/10; B60W 2520/14; B60W 2520/20; B60W 2554/4041; B60W 2554/4044; B60W 2554/801; B60W 2554/802

(57) ABSTRACT

A method for emergency collision avoidance of an intelligent vehicle includes: obtaining perception information of a vehicle and obtaining a reference trajectory based on a preset driving task, with an autonomous driving system of the vehicle; obtaining an expected response value of an actuator by calculating the task reference trajectory and the perception information with an autonomous collision avoidance system; and executing a response instruction of the expected response value with a vehicle chassis system, and implementing an emergency collision avoidance function of the vehicle when completing a tracking task along a given path based on an instruction response result.

### CROSS-REFERENCE TO RELATED APPLICATION

This application is the U.S. National Stage Application of International Application No. PCT/CN2023/095723, filed on May 23, 2023, which claims priority to Chinese Patent Application No. 2023100848077 filed in China on Jan. 18, 2023, the entire disclosure of which is incorporated herein by reference.

### TECHNICAL FIELD

The present disclosure relates to the technical field of active safety control of a vehicle, and in particular to a method and a system for emergency collision avoidance of an intelligent vehicle.

### BACKGROUND

As a vehicle popularizing rate increases, road traffic conditions have deteriorated sharply and the incidence of traffic accidents has increased dramatically. Therefore, the research and development of an active safety system may become a key link in the future implementation of an autonomous driving vehicle.

A crucial function in the active safety system of a vehicle is active collision avoidance. Based on information on the detected obstacles or other vehicles in front of the vehicle, an active collision avoidance system of the vehicle may alert a driver before an accident occurs, and automatically initiate, through dynamic intervention in emergency situations, emergency braking and emergency lane change to avoid the vehicle and automatically implement safety measures. As such, the occurrence of vehicle collision accidents is effectively reduced.

### SUMMARY

According to a first aspect of the disclosure, a method for emergency collision avoidance of an intelligent vehicle is provided. The method includes: obtaining perception information of a vehicle and obtaining a reference trajectory based on a preset driving task, with an autonomous driving system of the vehicle; obtaining an expected response value of an actuator by calculating the reference trajectory and the perception information with an autonomous collision avoidance system; and executing a response instruction of the expected response value with a vehicle chassis system, and implementing an emergency collision avoidance function of the vehicle when completing a tracking task along a given path based on an instruction response result.

According to a second aspect of the disclosure, a system for emergency collision avoidance of an intelligent vehicle is provided. The system includes: an autonomous driving system, configured to obtain perception information of a vehicle and obtain a reference trajectory based on a preset driving task; an autonomous collision avoidance system, configured to obtain an expected response value of an actuator by calculating the reference trajectory and the perception information; and a vehicle chassis execution system, configured to execute a response instruction of the expected response value, and implement an emergency collision avoidance function of the vehicle when completing a tracking task along a given path based on an instruction response result.

According to a third aspect of the embodiments of the disclosure, a non-transitory computer readable storage medium having a computer program stored is provided. When the computer program is executed by a processor, the method for emergency collision avoidance of an intelligent vehicle according to the first aspect is implemented.

### BRIEF DESCRIPTION OF THE DRAWINGS

The above and/or additional aspects and advantages of the present disclosure will become apparent and easily understood from the following description of the embodiments in conjunction with the accompanying drawings, in which:

FIG. 1 is a flowchart of a method for emergency collision avoidance of an intelligent vehicle according to an embodiment of the disclosure;

FIG. 2 is a diagram of a scenario for vehicle emergency collision avoidance according to an embodiment of the present disclosure;

FIG. 3 is a structure diagram of a system for emergency collision avoidance of an intelligent vehicle according to an embodiment of the present disclosure.

FIG. 4 is a computer device according to an embodiment of the present disclosure.

### DETAILED DESCRIPTION

It should be noted that, in the absence of conflicts, the embodiments and features in the embodiments of the present disclosure may be combined with each other. The present disclosure will be described in detail below with reference to the accompanying drawings and in conjunction with embodiments.

In order to enable those skilled in the art to better understand the embodiments of the present disclosure, the technical solutions in the embodiments of the present disclosure will be clearly and completely described below in conjunction with the drawings in the embodiments of the present disclosure. The described embodiments are only part of the embodiments of the present disclosure, rather than all of the embodiments. Based on the embodiments in the present disclosure, all other embodiments obtained by those skilled in the art without making any creative works should fall within the protection scope of the present disclosure.

The research and development of emergency collision avoidance function and system for smart cars, as a key link of active safety technology for autonomous driving, has been carried out to a certain extent. For example, Chinese Patent publication No. CN107672587A proposes a system and a method for emergency collision avoidance, including a trajectory prediction unit, a judgment unit, a calculation unit and a control unit. The trajectory prediction unit continuously predicts trajectories of the vehicle and its surrounding vehicles. The judgment unit calculates a vehicle driving risk. The calculation unit generates an expected collision avoidance trajectory. The tracking of the expected trajectory is implemented in the control unit. The system design adopts a layered architecture, which first generates a collision avoidance trajectory through perception of the surrounding environment and prediction and judgement of dangers, and tracks the trajectory after obstacle avoidance through a coordination of chassis actuators. However, the layered architecture requires coordination between the trajectory planning layer and the tracking control layer. The timeliness issues of asynchronous clock sampling and collision avoidance planning in multi-domain coordination are difficult to avoid. Chinese Patent No. CN107878453B proposes an integrated control method for emergency collision avoidance of a vehicle to avoid dynamic obstacles. In the method, a module for path dynamic planning and real-time tracking control is used to obtain a turning angle of a front wheel of the vehicle through real-time optimization, which achieves integrated control of vehicle collision avoidance and tracking. However, a widely used algorithm for integrated planning and control based on a rolling time domain requires too much computing power for optimization and is difficult to implement through programming. These defects further restrict the application and implementation of the active safety system on emergency collision avoidance in actual vehicles.

In order to solve the above problem, embodiments of the disclosure provide a method and a system for emergency collision avoidance of an intelligent vehicle, a computer device, a non-transitory computer readable storage medium, a computer program product, and a computer program.

According to the method and system for emergency collision avoidance of an intelligent vehicle, the computer device, the non-transitory computer readable storage medium, the computer program product, and the computer program in the embodiments of the disclosure, the active safety of the vehicle is improved, the occurrence of rear-end collision accidents are effectively reduced, with high practicality.

The embodiments of the disclosure constructs an algorithm integrated with collision avoidance and path tracking for the intelligent driving vehicle, so that the vehicle may effectively avoid dynamic and static obstacles while completing the given task trajectory tracking. The integrated design integrates vehicle planning, collision avoidance decision-making and control, which reduces the difficulties of multi-domain vehicle coordination and asynchronous communication sampling and adjustment.

All design steps in the embodiments of the present disclosure are analytical solutions. Compared with a widely used model predictive control algorithm, the method in the embodiments of the present disclosure is easy to program and requires less computing power, which is more conducive to practical application of vehicle controllers.

The following describes a method and a system for emergency collision avoidance of an intelligent vehicle, a computer device, a non-transitory computer readable storage medium, a computer program product, and a computer program.

FIG. 1 is a flowchart of a method for emergency collision avoidance of an intelligent vehicle according to an embodiment of the disclosure.

As shown in FIG. 1, the method includes but is not limited to steps S1-S3.

At S1, based on an autonomous driving system of the vehicle, perception information of a vehicle is obtained and a task reference trajectory is obtained based on a preset driving task.

At S2, an expected response value of an actuator is obtained by calculating the task reference trajectory and the perception information with an autonomous collision avoidance system.

At S3, a response instruction of the response value is executed with a vehicle chassis system, and an emergency collision avoidance function of the vehicle is implemented when completing a tracking task along a given path based on an instruction response result.

Specifically, in the embodiment of the disclosure, a reference trajectory is planned through the automatic driving system of the vehicle based on a preset task, a surrounding environment of the vehicle is perceived/sensed to obtain information about surrounding obstacles; the expected response value of the actuator is obtained by direct calculation based on the given reference trajectory and the obstacle information obtained through perception through the autonomous collision avoidance system module; the vehicle chassis system executes, based on the expected response value of the actuator, the expected response value to implement the emergency collision avoidance function of the vehicle.

In the embodiment, lateral and longitudinal coordinates of an expected trajectory planned based on the given task in step S1 are marked as (X_{d},Y_{d}), real-time position information of the obstacle is (Xₒ,Yₒ), and a relative distance between a position of the vehicle and the obstacle is calculated as Δxₒₑ=\sqrt{(X−Xₒ)²+(Y−Yₒ)²}, where X and Y are lateral and longitudinal positions of the vehicle.

In the embodiment, the above step S2 is mainly responsible for integrated implementation about reference trajectory tracking and active collision avoidance functions. A collision risk function of the obstacle is defined as:

$${U}_{od} = {A}_{f} \cdot exp [ - \frac{{( Δ {x}_{oe} )}^{2 c}}{2 {μ}^{2 c}} ] . \qquad ( 1 )$$

In the above formula (1), A_{f} is a risk evaluation gain, Δxₒₑ is a relative distance between the vehicle and the obstacle, the power exponent c is a sensitivity degree to a collision risk, the function exp(⋅) is an exponential function, and the parameter μ is an obstacle warning distance. The above collision risk function may be freely defined by a designer, but must meet a requirement of positive definiteness to facilitate a subsequent controller design. The embodiment is only as a reference.

A safety barrier function is designed based on the above collision risk, which is expressed as:

$${B}_{D} ( X ) = \frac{{U}_{o d}}{2 \cdot ln ( Δ {x}_{o e}^{2} - {r}^{2} )} \qquad ( 2 )$$

In the above formula (2), the parameter r is a limit collision safety distance and the function ln(⋅) is a logarithmic function. Similarly, the safety barrier function in the embodiment may be freely defined by the designer as long as it meets the requirement of positive definiteness. An integral heuristic Barrier Lyapunov function may be designed based on the safety barrier function as follows:

$${V}_{IM} ( t ) = ( {\int }_{τ = 0}^{t} {B}_{D} ( X ( τ ) ) d τ + 1 ) {‖ {Y}_{e} ( t ) ‖}^{2} \qquad ( 3 )$$

In the above formula (3), Yₑ is an lateral displacement error of the vehicle. An expected value of a yaw angle of the vehicle may be obtained based on the integral heuristic Barrier Lyapunov function in combination with a vehicle operation geometric model as follows:

$${ψ}_{d} = \frac{{k}_{1} \cdot exp ( - ϑ \cdot {B}_{D} ( X ) )}{{v}_{x}} sgn ( {Y}_{e} ) + \frac{{k}_{2} \cdot {B}_{D} ( X ) {Y}_{e}}{( {\int }_{τ = 0}^{t} {B}_{D} ( X ( τ ) ) d τ + 1 ) {v}_{x}} + \frac{{\dot{Y}}_{d}}{{v}_{x}} - β \qquad ( 4 )$$

In the above formula (4), vₓ is a longitudinal velocity of the vehicle, β is a sideslip angle of a center of mass of the vehicle that may be obtained by on-board sensors or existing estimation methods, Y_{d} is a lateral expected position of an expected trajectory obtained by planning based on a given task in an autonomous driving layer at the above step S1, k₁,k₂ are positive coefficients of a controller, and τ is an integral variable of an integrator. In the expected yaw angle design, path tracking and active safety collision avoidance functions are considered in an integrated manner, and an embedded design of the active safety function and secondary planning of collision avoidance operations are realized under the original planned reference trajectory in an analytical way. It is worth noting that the implementation of the active safety function in the embodiment of the present disclosure does not involve replanning to obtain a new reference trajectory, but instead directly obtaining the expected yaw angle of the vehicle that is integrated with the collision avoidance function, so that the active safety function may be integrated into a chassis motion control layer of the vehicle, which may effectively improve the intelligence and safety of the chassis motion control.

In addition, relying on the existing expected yaw angle tracking algorithm, the expected yaw angle is converted and allocated as an expected response value of the vehicle chassis actuator. Without loss of generality, this embodiment may be applied to vehicles with a front-wheel drive, a rear-wheel drive, or a four-wheel drive. The difference mainly lies in conversion and tracking of the expected yaw angle to the underlying actuator response under different chassis architectures.

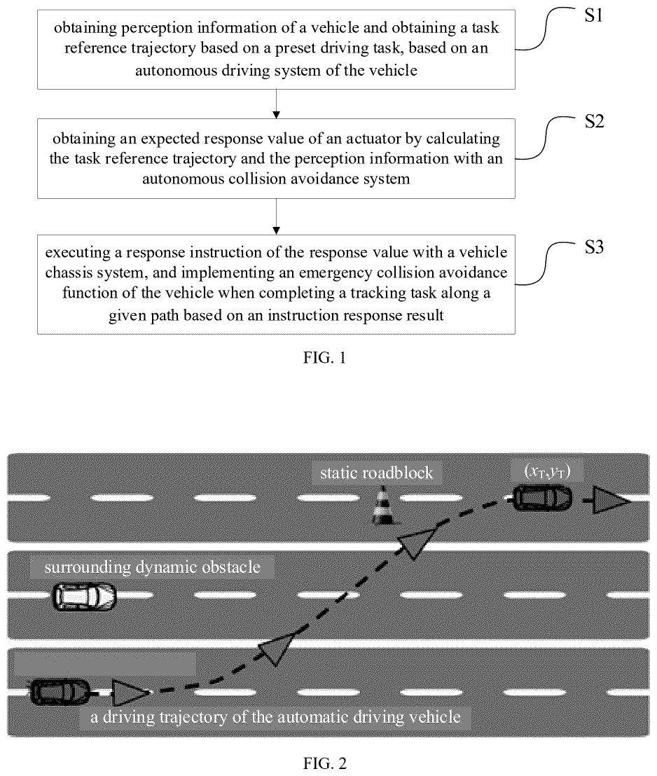

As an implementation, as shown in FIG. 2, the embodiment of the present disclosure takes a lane changing scenario of an autonomous driving vehicle under urban conditions as an embodiment. During the lane changing process, sudden accidents involving surrounding vehicles or a sudden appearance of driving vehicles in the surrounding area may affect implementation of a lane changing trajectory originally planned. Therefore, it is of great significance to activate the active collision avoidance function to ensure safety of the vehicle when changing lanes. The algorithm for active collision avoidance designed in the present disclosure may effectively improve active safety of the vehicle. The embodiment expects that the vehicle may avoid all potential collision risks while maintaining a given reference lane-changing trajectory. By actively executing a collision avoidance strategy and re-planning and calculating the expected yaw angle under the original lane changing trajectory, the entire lane changing operation may be achieved safely, quickly and smoothly.

According to the method for emergency collision avoidance of an intelligent vehicle in the embodiments of the present disclosure, in combination with the provided vehicle surrounding information perception and global trajectory planning, the autonomous collision avoidance system directly obtains, based on the task reference trajectory and surrounding obstacle information, the expected response from the actuator through the obstacle function, and the chassis execution system executes the expected response, which achieves the purpose of correcting the trajectory in real time to avoid collisions while tracking the original reference trajectory. The autonomous collision avoidance system achieves integration of expected trajectory tracking and active collision avoidance functions by introducing the heuristic Barrier Lyapunov function in an analytical way. The method for emergency collision avoidance of an intelligent vehicle provided by the embodiments of the present disclosure improves the active safety of the vehicle, effectively reduces the occurrence of rear-end collision accidents, and has high practicality.

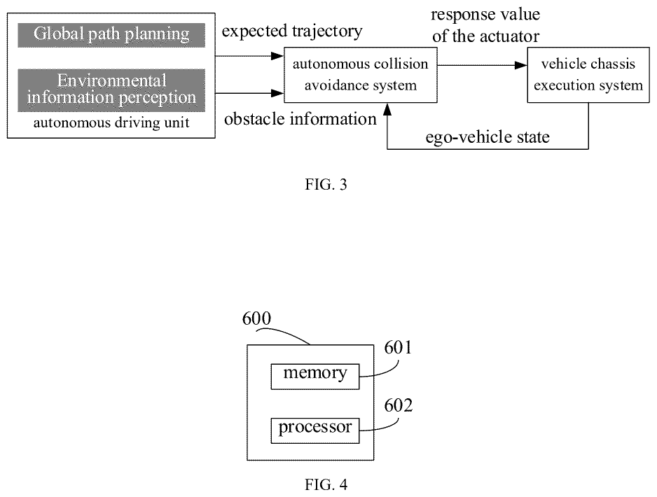

In order to implement the above embodiments, as shown in FIG. 3, a system 10 for emergency collision avoidance of an intelligent vehicle is also provided in the embodiment. The system 10 includes an automatic driving unit 1, an autonomous collision avoidance system 2 and a vehicle chassis execution system 3.

The autonomous driving unit 1 is configured to based on an autonomous driving system of the vehicle, obtain perception information of a vehicle and obtain a task reference trajectory based on a preset driving task.

The autonomous collision avoidance system 2 is configured to obtain an expected response value of an actuator by calculating the task reference trajectory and the perception information.

The vehicle chassis execution system 3 is configured to execute a response instruction of the response value, and implement an emergency collision avoidance function of the vehicle when completing a tracking task along a given path based on an instruction response result.

Specifically, the embodiments of the disclosure obtains the expected task trajectory and the position perception of surrounding obstacles from the automatic driving unit 1, and calculates the relative distance between the vehicle and the obstacle. The autonomous collision avoidance system 2 first determines the collision risk of the vehicle based on the relative position of the obstacle, and designs a heuristic Barrier Lyapunov function. The heuristic Barrier Lyapunov function is used to obtain the expected yaw angle after replanning that integrates with the active collision avoidance function, precise tracking of the yaw angle is implemented based on the chassis system configuration, and the expected yaw angle is converted into the expected response value of the vehicle chassis sub-actuator system. The vehicle chassis execution system 3 implements accurate tracking and executing of the reference value of the actuator, ensuring that the vehicle may track the reference trajectory while taking into account the active collision avoidance function.

According to the system for emergency collision avoidance of an intelligent vehicle in the embodiments of the present disclosure, in combination with the provided vehicle surrounding information perception and global trajectory planning, the autonomous collision avoidance system directly obtains, based on the task reference trajectory and surrounding obstacle information, the expected response from the actuator through the obstacle function, and the chassis execution system executes the expected response, which achieves the purpose of correcting the trajectory in real time to avoid collisions while tracking the original reference trajectory. The autonomous collision avoidance system achieves integration of expected trajectory tracking and active collision avoidance functions by introducing the heuristic Barrier Lyapunov function in an analytical way. The method for emergency collision avoidance of an intelligent vehicle provided by the embodiments of the present disclosure improves the active safety of the vehicle, effectively reduces the occurrence of rear-end collision accidents, and has high practicality.

In order to implement the method in the above-mentioned embodiments, the embodiment of the present disclosure also provides a computer device. As shown in FIG. 4, the computer device 600 includes a memory 601 and a processor 602. A program corresponding to an executable program code is executed by the processor 602 after reading the executable program code stored in the memory 601, so as to implement the method for emergency collision avoidance of an intelligent vehicle as described in any of the above-mentioned embodiments.

The embodiments of the disclosure also provide a non-transitory computer readable storage medium on which a computer program is stored. When the program is executed by a processor, the method for emergency collision avoidance of an intelligent vehicle as described in any of the above-mentioned embodiments is implemented.

The embodiments of the disclosure also provide a computer program product including a computer program, which, when executed by a processor, implements the method for emergency collision avoidance of an intelligent vehicle as described in any of the above-mentioned embodiments.

The embodiments of the disclosure also provide a computer program, including a computer program code. When the computer program code is running on a computer, the computer is enabled to execute the method for emergency collision avoidance of an intelligent vehicle as described in any of the above-mentioned embodiments.

It should be noted that the aforementioned explanations and descriptions of the embodiments of the method and system for emergency collision avoidance of an intelligent vehicle, the computer device are also applicable to the storage medium, the computer program product and the computer program in the above embodiments, which will not be repeated here.

In addition, the terms “first” and “second” are used for descriptive purposes only and cannot be understood as indicating or implying relative importance or implicitly indicating the quantity of the indicated technical features. Therefore, the features defined as “first” or “second” may explicitly
or implicitly include at least one of the features. In the description of the present disclosure, “a plurality of” means at least two, for example, two, three, etc., unless otherwise clearly and specifically defined.

In the description of the disclosure, the description with reference to terms such as “one embodiment”, “some embodiments”, “example”, “specific example”, or “some examples” means that the specific features, structures, materials or characteristics described in conjunction with the embodiment or example are included in at least one embodiment or example of the present disclosure. In the present specification, exemplary expressions of the above terms do not necessarily refer to the same embodiment or example. Furthermore, the specific features, structures, materials, or characteristics described may be combined in any suitable manner in any one or more embodiments or examples. Furthermore, those skilled in the art may combine and associate different embodiments or examples and features in different embodiments or examples described in the description without conflicts from each other.

Although the embodiments of the present disclosure have been shown and described above, it is to be understood that the above embodiments are exemplary and are not to be construed as limitations of the present disclosure. A person skilled in the art may change, modify, replace and vary the above embodiments within the scope of the present disclosure.

All embodiments of the present disclosure may be implemented individually or in combination with other embodiments, and are deemed to be within the protection scope required by the present disclosure.

1. A method for emergency collision avoidance of an intelligent vehicle, comprising:
obtaining perception information of a vehicle and obtaining a reference trajectory based on a preset driving task, with an autonomous driving system of the vehicle;
obtaining an expected response value of an actuator by calculating the reference trajectory and the perception information with an autonomous collision avoidance system; and
executing a response instruction of the expected response value with a vehicle chassis system, and implementing an emergency collision avoidance function of the vehicle when completing a tracking task along a given path based on an instruction response result.

2. The method according to claim 1, wherein the perception information comprises position information of the vehicle and position information of an obstacle; lateral and longitudinal coordinates of an expected trajectory of the task reference trajectory are marked as (X_{d},Y_{d}), the position information of the obstacle is (Xₒ,Yₒ), and a relative distance between the position information of the vehicle and the obstacle position information is calculated as Δxₒₑ=\sqrt{(X−Xₒ)²+(Y−Yₒ)²}, where X and Y are lateral and longitudinal positions of the vehicle.

3. The method according to claim 2, wherein a collision risk function of the obstacle is
$${U}_{o d} = {A}_{f} \cdot exp [ - \frac{{( Δ {x}_{o e} )}^{2 c}}{2 {μ}^{2 c}} ] \qquad ( 1 )$$
where A_{f} is a risk evaluation gain, Δxₒₑ is a relative distance between the vehicle and the obstacle, c is a sensitivity degree to a collision risk, exp(⋅) is an exponential function, and μ is an obstacle warning distance.

4. The method according to claim 3, wherein a safety barrier function is constructed based on the collision risk function, which is expressed as:
$${B}_{D} ( X ) = \frac{{U}_{o d}}{2 \cdot ln ( Δ {x}_{o e}^{2} - {r}^{2} )} \qquad ( 2 )$$
where r is a limit collision safety distance and ln(⋅) is a logarithmic function.

5. The method according to claim 4, wherein an integral heuristic Barrier Lyapunov function is constructed based on the safety barrier function:
$${V}_{IM} ( t ) = ( {\int }_{τ = 0}^{t} {B}_{D} ( X ( τ ) ) d τ + 1 ) {‖ {Y}_{e} ( t ) ‖}^{2} \qquad ( 3 )$$
where Yₑ is an lateral displacement error of the vehicle.

6. The method according to claim 5, wherein an expected value of a yaw angle of the vehicle is obtained based on the integral heuristic Barrier Lyapunov function and a vehicle operation geometric model, which is expressed as:
$${ψ}_{d} = \frac{{k}_{1} \cdot exp ( - ϑ \cdot {B}_{D} ( X ) )}{{v}_{x}} sgn ( {Y}_{e} ) + \frac{{k}_{2} \cdot {B}_{D} ( X ) {Y}_{e}}{( {\int }_{τ = 0}^{t} {B}_{D} ( X ( τ ) ) d τ + 1 ) {v}_{x}} + \frac{{\dot{Y}}_{d}}{{v}_{x}} - β \qquad ( 4 )$$
where vₓ is a longitudinal velocity of the vehicle, β is a sideslip angle of the vehicle, Y_{d} is a lateral expected position of an expected trajectory obtained by planning based on a given task in the autonomous driving system, k₁, k₂ are positive coefficients of a controller, and τ is an integral variable of an integrator.

7. A system for emergency collision avoidance of an intelligent vehicle, comprising:
an autonomous driving system, configured to obtain perception information of a vehicle and obtain a reference trajectory based on a preset driving task;
an autonomous collision avoidance system, configured to obtain an expected response value of an actuator by calculating the reference trajectory and the perception information;
a vehicle chassis execution system, configured to execute a response instruction of the response value, and implement an emergency collision avoidance function of the vehicle when completing a tracking task along a given path based on an instruction response result.

8. The system according to claim 7, wherein the perception information comprises position information of the vehicle and position information of an obstacle; lateral and longitudinal coordinates of an expected trajectory of the task reference trajectory are marked as (X_{d},Y_{d}), the position information of the obstacle is (Xₒ,Yₒ), and a relative distance between the position information of the vehicle and the obstacle position information is calculated as Δxₒₑ=\sqrt{(X−Xₒ)²+(Y−Yₒ)²}, where X and Y are lateral and longitudinal positions of the vehicle.

9. (canceled)

10. A non-transitory computer readable storage medium having a computer program stored thereon, wherein when the computer program is executed by a processor, a method for emergency collision avoidance of an intelligent vehicle is implemented, the method comprising:
obtaining perception information of a vehicle and obtaining a reference trajectory based on a preset driving task, with an autonomous driving system of the vehicle;
obtaining an expected response value of an actuator by calculating the reference trajectory and the perception information with an autonomous collision avoidance system; and
executing a response instruction of the expected response value with a vehicle chassis system, and implementing an emergency collision avoidance function of the vehicle when completing a tracking task along a given path based on an instruction response result.

11. A computer program product, comprising a computer program, wherein when the computer program is executed by a processor, the method for emergency collision avoidance of an intelligent vehicle according to claim 1 is implemented.

12. (canceled)

13. The system according to claim 7, wherein a collision risk function of the obstacle is
$${U}_{o d} = {A}_{f} \cdot exp [ - \frac{{( Δ {x}_{o e} )}^{2 c}}{2 {μ}^{2 c}} ] \qquad ( 1 )$$
where A_{f} is a risk evaluation gain, Δxₒₑ is a relative distance between the vehicle and the obstacle, c is a sensitivity degree to a collision risk, exp(⋅) is an exponential function, and μ is an obstacle warning distance.

14. The system according to claim 13, wherein a safety barrier function is constructed based on the collision risk function, which is expressed as:
$${B}_{D} ( X ) = \frac{{U}_{o d}}{2 \cdot ln ( Δ {x}_{o e}^{2} - {r}^{2} )} \qquad ( 2 )$$
where r is a limit collision safety distance and ln(⋅) is a logarithmic function.

15. The system according to claim 14, wherein an integral heuristic Barrier Lyapunov function is constructed based on the safety barrier function:
$${V}_{IM} ( t ) = ( {\int }_{τ = 0}^{t} {B}_{D} ( X ( τ ) ) d τ + 1 ) {‖ {Y}_{e} ( t ) ‖}^{2} \qquad ( 3 )$$
where Yₑ is an lateral displacement error of the vehicle.

16. The system according to claim 15, wherein an expected value of a yaw angle of the vehicle is obtained based on the integral heuristic Barrier Lyapunov function and a vehicle operation geometric model, which is expressed as:
$${ψ}_{d} = \frac{{k}_{1} \cdot exp ( - ϑ \cdot {B}_{D} ( X ) )}{{v}_{x}} sgn ( {Y}_{e} ) + \frac{{k}_{2} \cdot {B}_{D} ( X ) {Y}_{e}}{( {\int }_{τ = 0}^{t} {B}_{D} ( X ( τ ) ) d τ + 1 ) {v}_{x}} + \frac{{\dot{Y}}_{d}}{{v}_{x}} - β \qquad ( 4 )$$
where vₓ is a longitudinal velocity of the vehicle, β is a sideslip angle of the vehicle, Y_{d} is a lateral expected position of an expected trajectory obtained by planning based on a given task in the autonomous driving system, k₁,k₂ are positive coefficients of a controller, and τ is an integral variable of an integrator.

17. The storage medium according to claim 10, wherein the perception information comprises position information of the vehicle and position information of an obstacle; lateral and longitudinal coordinates of an expected trajectory of the task reference trajectory are marked as (X_{d},Y_{d}), the position information of the obstacle is (Xₒ,Yₒ), and a relative distance between the position information of the vehicle and the obstacle position information is calculated as Δxₒₑ=\sqrt{(X−Xₒ)²+(Y−Yₒ)²}, where X and Y are lateral and longitudinal positions of the vehicle.

18. The storage medium according to claim 17, wherein a collision risk function of the obstacle is
$${U}_{o d} = {A}_{f} \cdot exp [ - \frac{{( Δ {x}_{o e} )}^{2 c}}{2 {μ}^{2 c}} ] \qquad ( 1 )$$
where A_{f} is a risk evaluation gain, Δxₒₑ is a relative distance between the vehicle and the obstacle, c is a sensitivity degree to a collision risk, exp(⋅) is an exponential function, and μ is an obstacle warning distance.

19. The storage medium according to claim 18, wherein a safety barrier function is constructed based on the collision risk function, which is expressed as:
$${B}_{D} ( X ) = \frac{{U}_{o d}}{2 \cdot ln ( Δ {x}_{o e}^{2} - {r}^{2} )} \qquad ( 2 )$$
where r is a limit collision safety distance and ln(⋅) is a logarithmic function.

20. The storage medium according to claim 19, wherein an integral heuristic Barrier Lyapunov function is constructed based on the safety barrier function:
$${V}_{IM} ( t ) = ( {\int }_{τ = 0}^{t} {B}_{D} ( X ( τ ) ) d τ + 1 ) {‖ {Y}_{e} ( t ) ‖}^{2} \qquad ( 3 )$$
where Yₑ is an lateral displacement error of the vehicle.

21. The storage medium according to claim 20, wherein an expected value of a yaw angle of the vehicle is obtained based on the integral heuristic Barrier Lyapunov function and a vehicle operation geometric model, which is expressed as:
$${ψ}_{d} = \frac{{k}_{1} \cdot exp ( - ϑ \cdot {B}_{D} ( X ) )}{{v}_{x}} sgn ( {Y}_{e} ) + \frac{{k}_{2} \cdot {B}_{D} ( X ) {Y}_{e}}{( {\int }_{τ = 0}^{t} {B}_{D} ( X ( τ ) ) d τ + 1 ) {v}_{x}} + \frac{{\dot{Y}}_{d}}{{v}_{x}} - β \qquad ( 4 )$$
where vₓ is a longitudinal velocity of the vehicle, β is a sideslip angle of the vehicle, Y_{d} is a lateral expected position of an expected trajectory obtained by planning based on a given task in the autonomous driving system, k₁,k₂ are positive coefficients of a controller, and τ is an integral variable of an integrator.
